(19) United States
(12) Patent Application Publication
(10) Pub. No.: US 2013/0035849 A1
(43) Pub. Date: Feb. 7, 2013

(54) Navigation Apparatus Having Three-Dimensional Gravity Sensor and Navigation Method Thereof

(71) Applicant: Shi-Xiang SHEN, Shanghai (CN)

(72) Inventor: Shi-Xiang SHEN, Shanghai (CN)

(73) Assignees: MITAC RESEARCH (SHANGHAI) LTD., Shanghai (CN); MITAC INTERNATIONAL CORP., Kuei San Township (TW)

(21) Appl. No.: 13/221,139

(22) Filed: Aug. 30, 2011

(30) Foreign Application Priority Data
Aug. 1, 2011 (CN) 201110218606.9

(51) Int. Cl. G01C 21/34

(52) U.S. Cl. 701/423; 701/500

(57) ABSTRACT

A navigation apparatus with three-dimensional gravity sensor and a navigation method thereof. The navigation apparatus comprises an input module, a three-dimensional gravity sensor module, a processing module and a storage module. The input module inputs an initial point, a destination and a special road section. The three-dimensional gravity sensor module senses a three-dimensional acceleration of the navigation apparatus. The processing module calculates road condition information according to the three-dimensional acceleration. The storage module stores the road condition information and map information.

### BACKGROUND OF THE INVENTION

1. Field of the Invention

The present invention relates to a navigation apparatus having three-dimensional gravity sensor and a navigation method thereof, and more particularly to a navigation apparatus having three-dimensional gravity sensor and a navigation method thereof capable of sensing three-dimensional acceleration and storing road condition information.

2. Description of the Related Art

Lots of navigation apparatuses have functions of planning routes, recommending routes and searching roads. The accuracy of the conventional navigation apparatus tends to be influenced by worse receiving of GPS signals. Thus, higher level navigation apparatuses may be equipped with gyroscopes to help positioning in order to continuously perform navigation and positioning while receiving no GPS signals.

The gyroscope is used for figuring out instantaneous relative acceleration, relative direction and angle variations by detecting movement status of objects such as velocity, braking or turning according to the law of inertia. The gyroscope can help the navigation system to exactly detect the movement velocity and direction of vehicles by calculation processing, such as Taiwan patent number 200811419.

Although the conventional gyroscope can calculate the movement velocity and direction of vehicles, it is unable to record or remind drivers to determine whether road conditions, such as roughness, unevenness, over-curvature or crowded road sections, are avoided. The drivers are also unable to receive warning in advance or avoid specific road sections while facing the specific road sections.

As far as market requirements are concerned, designing a navigation apparatus having a three-dimensional gravity sensor and navigation method thereof to have efficacy of avoiding specific road sections or warning reminder except that it effectively senses three-dimensional acceleration and records road conditions has become an important issue in market applications.

### SUMMARY OF THE INVENTION

In view of the shortcomings of the prior art, the inventor(s) of the present invention based on years of experience in the related industry to conduct extensive researches and experiments, and finally developed a navigation apparatus having a three-dimensional gravity sensor and navigation method thereof as a principle objective to overcome the problems that are unable to record specific road conditions, send warning messages and re-plan navigation routes in route information in the prior art.

To achieve the foregoing objective, a navigation apparatus is provided and comprises an input module, a sensing module, a processing module and a storage module. The input module is used for inputting a starting point, a destination and a specific road section to be avoided or warned. The sensing module senses a three-dimensional acceleration. The processing module calculates road condition information based upon the three-dimensional acceleration. The storage module stores the road condition information and map information.

The navigation apparatus further comprises a signal module. The signal module sends a signal based upon the road condition information.

The road condition information further comprises specific road condition information.

The specific road condition information comprises roughness, slope rise, over-curvature or crowded road section.

The input module is used for inputting a command of determining whether the specific road section is to be avoided or warned.

The processing module plans route information based upon the starting point, the destination and the specific road section to be avoided or warned and map information.

The navigation apparatus further comprises a display module. The display module displays the road condition information and the route information.

To achieve the foregoing objective, a navigation method applied to a navigation apparatus having an input module, a sensing module, a processing module and a storage module is also provided and comprises the following steps: using the input module to input a starting point, a destination and a specific road section to be avoided or warned; sensing a three-dimensional acceleration through the sensing module; utilizing the processing module to calculate road condition information based upon the three-dimensional acceleration; and storing the road condition information and map information through the storage module.

The method further comprises a step of using a signal module to send a signal based upon the road condition information.

The method further comprises a step of using the signal module to send the signal based upon specific road condition information.

The method further comprises a step of inputting a command of determining whether the specific road section is avoided or warned through the input module.

The method further comprises a step of planning route information based upon the starting point, the destination and the specific road section to be avoided or warned and map information.

The method further comprises a step of displaying the road condition information and the route information through a display module.

The navigation apparatus having a three-dimensional gravity sensor and navigation method thereof of the invention have at least one or more advantages as the following:
(1) The invention can utilize the sensing module to sense the three-dimensional acceleration and record road conditions through the storage module and has efficacy of avoiding the specific road sections and warning reminder.
(2) The invention can be taken as a racing detector to directly record and display gravity acceleration at a bend or can be taken as a comfort detector of automobile industries or a reference for normal drivers to choose a comfortable road.

### BRIEF DESCRIPTION OF THE DRAWINGS

FIG. 1 is a block diagram of a navigation apparatus of the invention;

FIG. 2 is a flowchart of a navigation method according to a first embodiment of the invention;

FIG. 3 is a flowchart of a navigation method according to a second embodiment of the invention; and

FIG. 4 is a flowchart of a navigation method according to a third embodiment of the invention.

### DETAILED DESCRIPTION OF THE PREFERRED EMBODIMENTS

The foregoing and other technical characteristics of the present invention will become apparent with the detailed description of the preferred embodiments and the illustration of the related drawings.

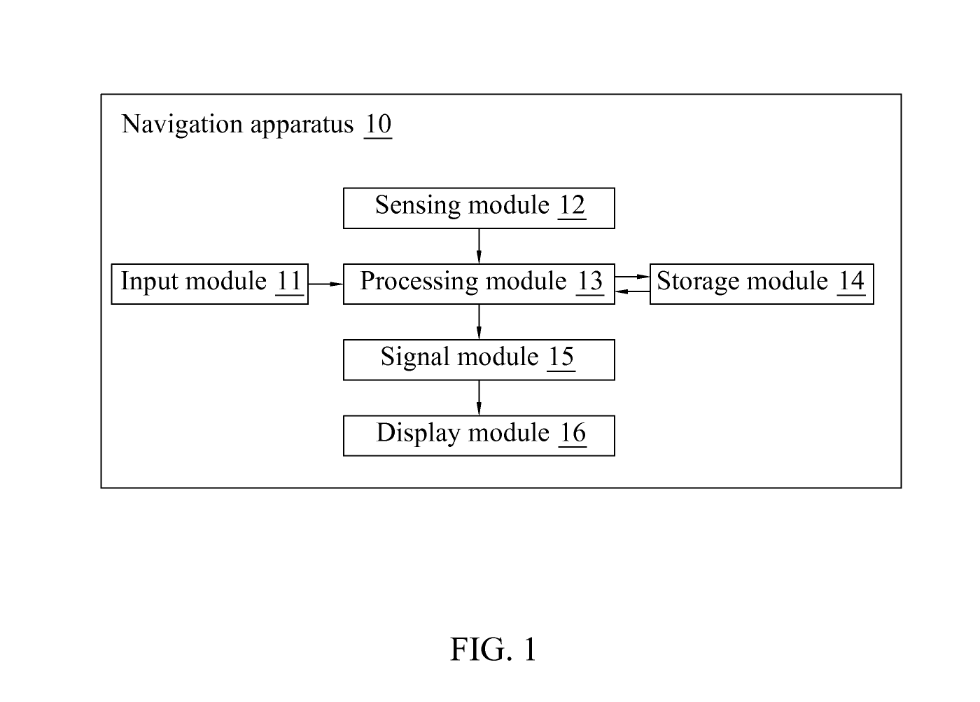

FIG. 1 is a block diagram of a navigation apparatus of the invention. With reference to FIG. 1, the navigation apparatus 10 comprises an input module 11, a sensing module 12, a processing module 13, a storage module 14, a signal module 15 and a display module 16. The input module 11 is used for inputting a starting point, a destination and a specific road section to be avoided or warned, or inputting commands of deciding whether or not the specific road section is avoided or warned. The sensing module 12 senses a three-dimensional acceleration. The processing module 13 calculates road condition information based upon the three-dimensional acceleration, wherein the road condition information comprises specific road condition information such as roughness, slope rise, over-curvature or crowded road section. The processing module 13 further plans route information based upon the starting point, the destination and the specific road section to be avoided or warned and map information. The storage module 14 stores the road condition information and the map information. The signal module 15 sends signals based upon the road condition information. The display module 16 displays the road condition information and the route information.

When the navigation apparatus 10 is shaken, rocked or vibrated due to changed road condition, the sensing module 12 can sense the three-dimensional acceleration generated by the shaking, rock or vibration corresponding to every kind of road condition.

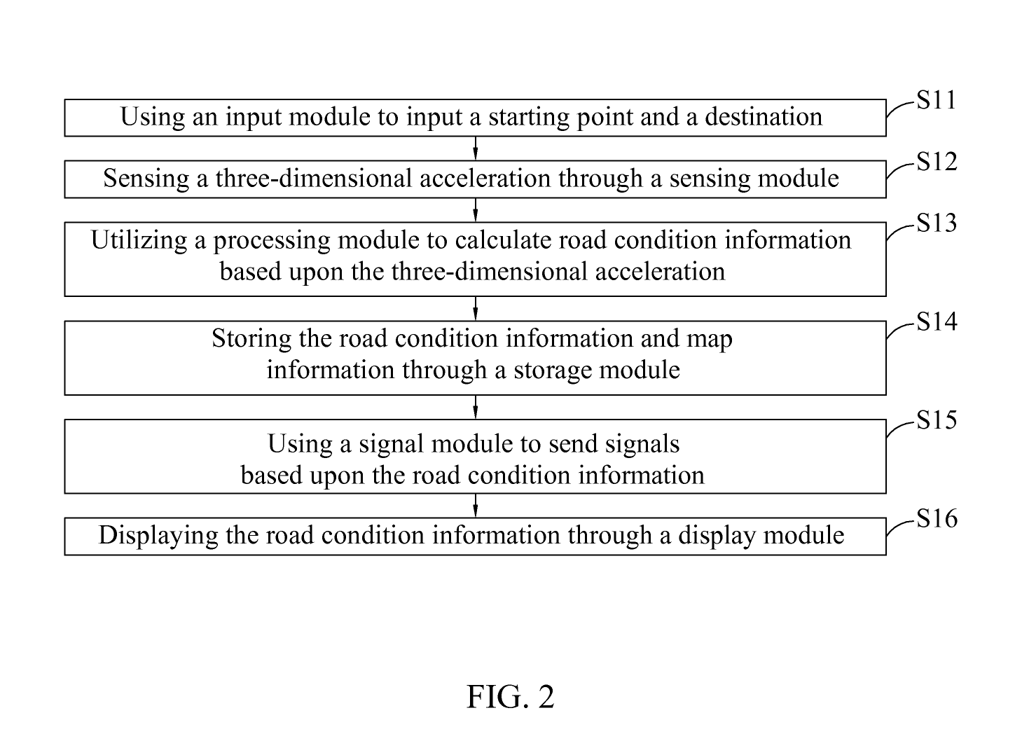

FIG. 2 is a flowchart of a navigation method according to a first embodiment of the invention. With reference to FIG. 1 and FIG. 2, firstly as shown in step S11 to step S13: step S11: using an input module to input a starting point and a destination; step S12: sensing a three-dimensional acceleration through a sensing module; step S13: utilizing a processing module to calculate road condition information based upon the three-dimensional acceleration. In step S13, the road condition information comprises specific road condition information. The specific road condition information can include roughness, slope rise, over-curvature or crowded road sections. Next, as shown in step S14 and step S15, step S14: storing the road condition information and map information through a storage module; and step S15: using a signal module to send signals based upon the road condition information.

It should be noted that in step S14, results calculated and sensed by step S13 and step S12 are stored in the storage module to provide backup information while the user passes through the same road section or confronts the same road condition information next time. Finally, as shown in step S16, displaying the road condition information through a display module.

According to the first embodiment, the invention further provides a second embodiment for detail depiction.

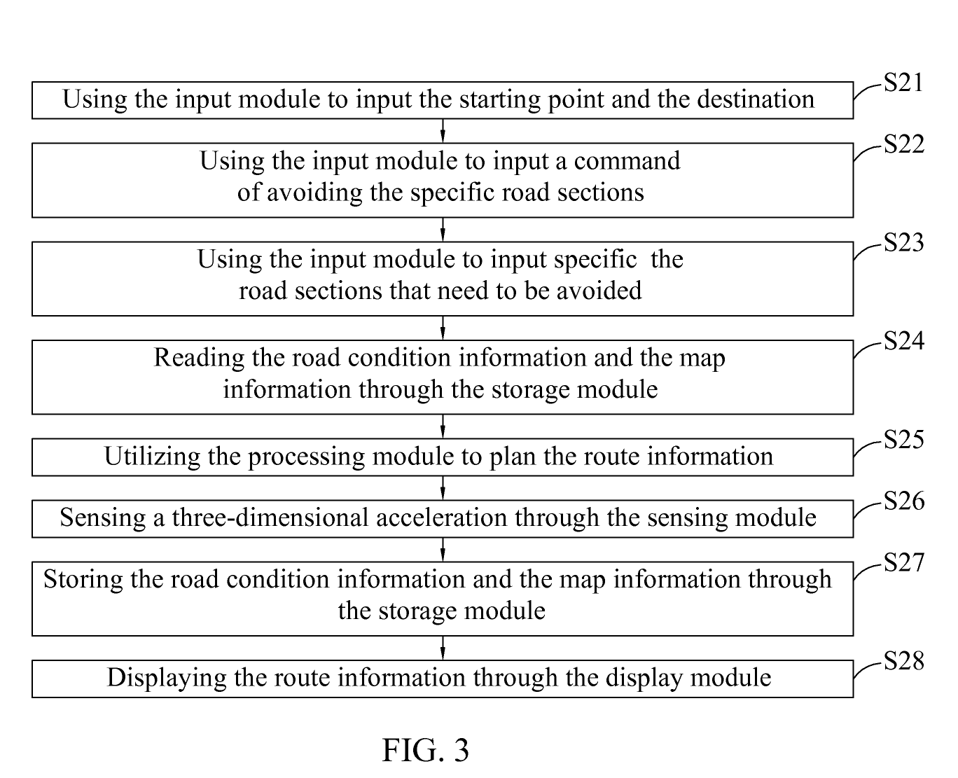

FIG. 3 is a flowchart of a navigation method according to a second embodiment of the invention. With reference to FIG. 3 and the block diagram of the navigation apparatus as shown in FIG. 1, firstly shown in step S21 and step S22, step S21: using the input module to input the starting point and the destination; and step S22: using the input module to input a command of avoiding the specific road sections. When the user determines to plan routes for avoiding the specific road sections via the input module, as shown in step S23 to step S25, step S23: using the input module to input the specific road sections that need to be avoided; step S24: reading the road condition information and the map information through the storage module; and step S25: utilizing the processing module to plan the route information.

It should be noted that in step S25, the processing module plans the route information based upon a GPS signal, the road condition information and the map information inputted and stored by the input module and the storage module.

While the user determines to avoid the specific road sections, as shown in step S26 to step 28, step S26: sensing a three-dimensional acceleration through the sensing module; step S27: storing the road condition information and the map information through the storage module; and step S28: displaying the route information through the display module.

Therefore, while moving along the route information, the three-dimensional acceleration and the newest road condition are sensed and stored respectively through the sensing module of step S26 and the storage module of step S27.

The present invention further provides a third embodiment for further illustration, besides the first and the second embodiment.

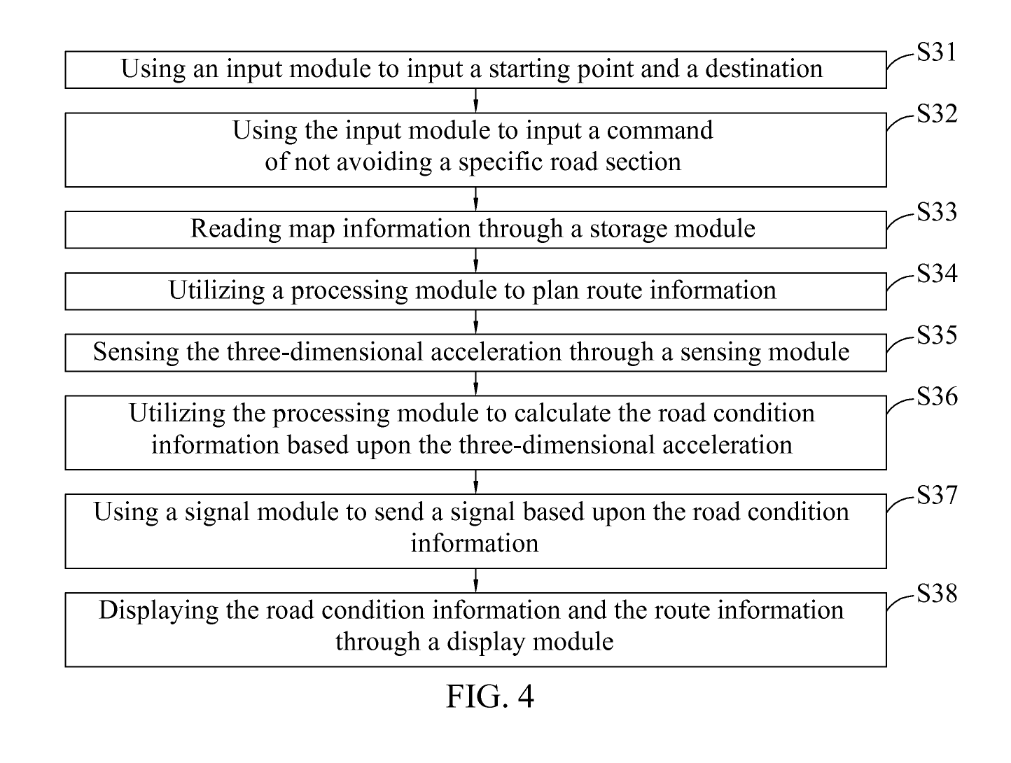

FIG. 4 is a flowchart of a navigation method according to the third embodiment of the invention. With reference to FIG. 4 and the block diagram of the navigation apparatus shown in FIG. 1, the navigation method comprises the following steps:

S31: using an input module to input a starting point and a destination;

S32: using the input module to input a command of not avoiding a specific road section;

S33: reading map information through a storage module; and

S34: utilizing a processing module to plan route information.

It should be noted that in step S34, the processing module plans the route information based upon a GPS signal, content inputted by the input module and the map information.

Next, as shown in step S35 to step S37, S35: sensing the three-dimensional acceleration through a sensing module; S36: utilizing the processing module to calculate the road condition information based upon the three-dimensional acceleration; and S37: using a signal module to send a signal based upon the road condition information. Finally, as shown in step S38: displaying the road condition information and the route information through a display module.

Accordingly, the road condition information and the map information stored by the storage module are read in step S34. While approaching the specific road sections such as roughness, slope rise, over-curvature or crowded road section, a user will be notified of being about to pass through the specific road sections by sending signals of step S37 and using the display module of step S38, thereby having warning and reminder effects.

The user can utilize the navigation method having a three-dimensional gravity sensor to allow the navigation apparatus to have the function of sensing three-dimensional acceleration. It does not only provide route planning for a driver, but also has efficacy of having warning and reminder with respect to current road condition information.

The invention improves over the prior art and complies with patent application requirements, and thus is duly filed for patent application. While the invention has been described by device of specific embodiments, numerous modifications and variations could be carried out without departing from the scope by those generally skilled in the art and the spirit of the invention is intended to be limited only by the appended claims.

What is claimed is:

1. A navigation apparatus comprising:
an input module for inputting a starting point, a destination and a specific road section to be avoided and warned;
a sensing module for sensing a three-dimensional acceleration;
a processing module for calculating road condition information based upon the three-dimensional acceleration; and
a storage module for storing the road condition information and map information.

2. The navigation apparatus as recited in claim 1, further comprising a signal module for sending a signal based upon the road condition information.

3. The navigation apparatus as recited in claim 1, wherein the road condition information further comprises specific road condition information.

4. The navigation apparatus as recited in claim 3, wherein the specific road condition information further comprises roughness, slope rise, over-curvature or crowded road section.

5. The navigation apparatus as recited in claim 1, wherein the input module is used for inputting a command of determining whether the specific road section is avoided or warned.

6. The navigation apparatus as recited in claim 1, wherein the processing module plans route information based upon the starting point, the destination and the specific road section to be avoided and warned and the map information.

7. The navigation apparatus as recited in claim 6, further comprising a display module, wherein the display module displays the road condition information and the route information.

8. A navigation method applied to a navigation apparatus having an input module, a sensing module, a processing module and a storage module, the navigation method comprising the following steps:
using the input module to input a starting point, a destination and a specific road section to be avoided or warned;
sensing a three-dimensional acceleration through the sensing module;
utilizing the processing module to calculate road condition information based upon the three-dimensional acceleration; and
storing the road condition information and map information through the storage module.

9. The navigation method as recited in claim 8, further comprising the following step:
using a signal module to send a signal based upon the road condition information.

10. The navigation method as recited in claim 9, further comprising the following step: using the signal module to send the signal based upon specific road condition information.

11. The navigation method as recited in claim 8, further comprising the following step:
inputting a command of determining whether the specific road section is avoided or warned through the input module.

12. The navigation method as recited in claim 8, further comprising the following step:
utilizing the processing module to plan route information based upon the starting point, the destination, the specific road section to be avoided or warned and the map information.

13. The navigation method as recited in claim 12, further comprising the following step:
displaying the road condition information and the route information through a display module.
